(19) United States
(12) Patent Application Publication
(10) Pub. No.: US 2002/0129897 A1
(43) Pub. Date: Sep. 19, 2002

(54) Method and device for manufacturing a composite part with a protection shell

(76) Inventors: Serge Gonzalez, Decines (FR); Paul Mariaggi, Seyssuel (FR); Dominique Audigier, Vourles (FR)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/094,709

(22) Filed: Mar. 12, 2002

(30) Foreign Application Priority Data
Mar. 13, 2001 (FR) 01/03.424

(51) Int. Cl. B29C 47/00

(52) U.S. Cl. 156/309.6; 156/330; 156/244.24

(57) ABSTRACT

The present invention relates to a method of manufacturing a part made of a composite material comprising reinforcing fibers embedded in a matrix made of a polymerizable and/or crosslinkable material, wherein:

at least one composite layer (3) is deposited on a mandrel (2),

the non-polymerized and/or non-crosslinked composite layer is coated with at least one protection layer (7) made of a hardenable material,

the protection layer is hardened before polymerization and/or crosslinking of the composite layer.

The invention also relates to a manufacturing device.

### FIELD OF THE INVENTION

The present invention relates to a device and to a method providing dimensional integrity of a composite part during the polymerization and/or crosslinking stage, and/or implementation of organic matrices forming, with the reinforcing fibers, the rigid part of the composite. What is understood to be a part in the sense of the invention is a tube, a pipe, a tank or any other element allowing to store or to carry liquids likely to contain suspended solids, gases, muds or a mixture of these elements. The part can consist of various superposed layers of different natures.

### BACKGROUND OF THE INVENTION

In the case of a thermosetting organic resin used as the composite matrix, the present invention proposes improvements in the use of resins referred to as B-stage resins which form the organic matrix of the composite, without deformation or draining of the impregnated or pre-impregnated reinforcing elements, during the stage of total polymerization by heating in an oven or any other equivalent crosslinking means. UV, IR or microwave sources can be mentioned by way of example.

What is referred to as B stage is the physical or chemical advanced state of a thermosetting resin that has not yet reached the gel point or its polymerization stage. The B stage defines the ideal time of use of the resin allowing all the stages of preparation of a composite before too high a dynamic viscosity and too high a reaction rate (crosslinking) are reached.

The present invention also proposes, for a thermoplastic organic matrix, an improvement in its use during the elaboration of a composite when the matrix is in such a viscosity state that a flow phenomenon is possible.

A continuous filament winding process generally requires a mandrel on which the reinforcing elements impregnated with a matrix are wound. The filaments (glass, carbon, aramid, . . . ) are impregnated with thermosetting resins or thermoplastic polymers by means of a dry or wet process, then they are wound on the mandrel before a later stage of polymerization of the resin or of local melting of the thermoplastic.

A metal or polymer tube obtained by continuous extrusion upstream from the manufacturing chain and kept in the core of the composite product can be used as the mandrel. It is also possible to use a tube consisting of a reinforcing fiber layer, impregnated or embedded in at least one thermoplastic organic matrix, at least one thermosetting matrix or a mixture of the two matrix types. It is also possible to use a mandrel in form of an endless band spirally wound on a rotating support but immovable in translation, which supports and drives the embedded fibers to the end of the polymerization stage and goes back to the starting point.

If the tube manufactured by means of a continuous filament winding process, for example with a diameter equal to or greater than 10 inches (25.4 mm), is intended to store or to carry, for a length of time of the order of twenty years without undergoing any deterioration, fluids such as oil and its components, gases, water, water with a high soluble or insoluble salts content, completion fluids or muds at temperatures (all these fluids can contain gas) ranging between 4° C. and 200° C., the pull winding process will be more particularly used, where the mandrel (liner), fixed in rotation but moving longitudinally, consists of a thermoplastic polymer, of a thermosetting polymer, of a mixture of fiber-reinforced polymers, or of a metal, and in a more particular application of at least one polymer selected from the group consisting of thermoplastic polymers (such as PE, PP, PA, PVDF, PEEK for example), and a system consisting of fibers and impregnation resins capable of not being degraded under the conditions of use. In fact, this process requires pre-impregnation of the reinforcing fibers by a specific operation carried out by means of conventional impregnation processes, then winding the assembly on reels that will be installed thereafter on one or more circular conveyors for the filament winding operation.

The conditions of use of the final multilayer composite structure in the more particular case of a composite riser of a TLP type (tension-leg platform) production platform can be summarized as follows:

Lifetime: about 20 years

Fluid temperature: ranging between 4° C. and 100° C.

Composite temperature: ranging between 4° C. and 90° C.

High chemical resistance of the organic matrix forming the composite:

to hydrolysis

to swelling due to water

to swelling due to oil and its constituents

to swelling due to reservoir gases

to pipe repair products.

High chemical resistance of the liner forming the mandrel during elaboration:

to oil (and gases)

to water (acid and basic)

to water containing soluble and insoluble salts

to completion muds and fluids.

The various working constraints of the final multilayer composite structure compel the designer to use very stable organic matrices. In a more particular embodiment of the invention, the resins can belong to the epoxides family, some of which are described in document FR-2,753,978. Their behaviour has been the subject of exhaustive studies in time and in the petroleum sphere.

These resins, which show excellent characteristics, have the distinctive feature of being less reactive at moderate temperature. The processability or latency time at the B stage is an important point in the design of the process. In fact, continuous manufacture requires a pre-impregnated fiber quality that has to be constant in time. Pre-impregnated reels whose resin content has been controlled are preferably used. This type of resin can therefore be used since it can remain without any notable viscosity evolution for a length of time equal to or greater than 1 day, usually about 10 days to about 2 months, at an average storage temperature equal to or less than 25° C., usually about 0° C. to about 15° C. and in most cases about 0° C. to about 5° C. Another important point concerns the viscosity evolution of the resin during the stage of polymerization of the multilayer composite obtained by filament winding. This evolution can be described as follows. As the tube progresses in the oven, a decrease in the viscosity of the resin is observed during warming up. This fluidification necessarily leads to dripping and gravity draining since the mandrel of the tube performs no rotation. The distribution of the organic matter in the fibers may therefore not be homogeneous. This resin will gradually reach a pasty state over a certain length of the oven. The structure can be deformed and out of round. The product being partly polymerized and therefore soft, it is not possible to draw it or to push it with track means (shoes, rollers or drawer) without harming the integrity of its structure.

To avoid such problems, flow controllers which modify the rheology of the system can be added to the resin. It is also possible to increase the length of the oven in order to reach the curing temperature very slowly so as to prevent draining of the fibers and/or to wrap the structure in a non-adherent plastic film. However, these measures are neither technically satisfactory nor economical.

### SUMMARY OF THE INVENTION

The object of the present invention is to protect the structure evolving towards the B stage by a more or less rigid protective shell (or <<continuous mould>>) manufactured or set upstream from the oven. The purpose of this protective shell is to prevent dripping and/or draining phenomena and to allow to handle and/or to transport the whole tube without any particular damage for the final structure. This shell must rapidly reach a sufficiently rigid state to meet the resistance requirements, notably the collapse strength, and its glass-transition temperature will preferably be higher than the polymerization temperature of the system coated thereby. What is referred to as the glass-transition temperature is the temperature defining the transition from the hard and brittle glassy state of the polymer to a rubbery state.

According to the invention, the distribution of the resin in the fibers remains homogeneous, the length of the oven can be decreased and the dimensional integrity of the final structure is respected by means of the shell.

The present invention thus relates to a method of manufacturing a composite part comprising reinforcing fibers embedded in a matrix made of a polymerizable and/or crosslinkable material, wherein:

at least one composite layer is deposited on a mandrel,

the non-polymerized and/or non-crosslinked composite layer is coated with at least one protection layer made of a hardenable material,

the protection layer is hardened before polymerization and/or crosslinking of the composite layer.

The material of the hardenable protection layer can be selected from the following group: thermosetting resins, thermoplastic polymers, rigid foams, cements, impregnated cloths.

The mandrel can be a continuous tube. What is referred to as continuous is a tube length, for example from 30 m and that can reach several hundred meters, which can be used for implementing the present manufacturing method.

The matrix of the composite material can be a B-stage composition.

The matrix can be a thermosetting composition, with low regain of water, oil and its components, having a glass-transition temperature of at least 100° C., preferably at least 120° C. and often at least 140° C., the composition comprising at least one epoxide resin formed from at least one polyepoxide containing in its molecule at least two epoxide groups and from at least one aromatic polyamine comprising in its molecule at least two primary amino groups, at least one alkanoyl substituent having 1 to 12 carbon atoms located at alpha of one of the amino groups, the amine to epoxide molar ratio ranging between 1:1.6 and 1:2.6.

The mandrel can be a tube made from a thermoplastic polymer, such as PE, PP, PA, PVDF, PEEK, extruded upstream from the composite layer deposition stage.

The mandrel can be a tube made of thermoplastic composite, thermosetting composite, composite made from an alloy (or mixture) of thermoplastic or thermosetting polymer, or a mixture of thermoplastic polymer and thermosetting polymer.

The mandrel can be a metal tube, a perforated metal or plastic tube, a metal or plastic lattice forming a tube, a rigid foam.

The protection layer can be deposited by extrusion.

The protection layer can consist of at least one layer of reinforcing fibers, impregnated or embedded in an organic matrix.

The invention also relates to a device for manufacturing a composite part comprising reinforcing fibers embedded in a matrix made of a polymerizable and/or crosslinkable material. The device comprises:

a mandrel on which at least one composite layer is deposited,

means for coating the non-polymerized and/or non-crosslinked composite layer with at least one protection layer made of a hardenable material,

means for hardening the protection layer before polymerization and/or crosslinking of the composite layer.

The device can comprise a manufacturing chain consisting of:

means for producing the mandrel, by extrusion for example,

means intended for filament winding of the composite layer on the mandrel,

means for setting the protection layer on the composite layer, extrusion means for example,

means for polymerizing the composite.

The means intended to harden the protection layer can be arranged upstream from said polymerization means.

### BRIEF DESCRIPTION OF THE DRAWINGS

Other features and advantages of the present invention will be clear from reading the description hereafter of non limitative examples, with reference to the accompanying figures wherein:

FIGS. 1A and 1B show a tubular part according to the prior art and according to the invention,

FIGS. 2A and 2B diagrammatically show a device for manufacturing a tubular part, according to the prior art and according to the present invention respectively.

### DETAILED DESCRIPTION

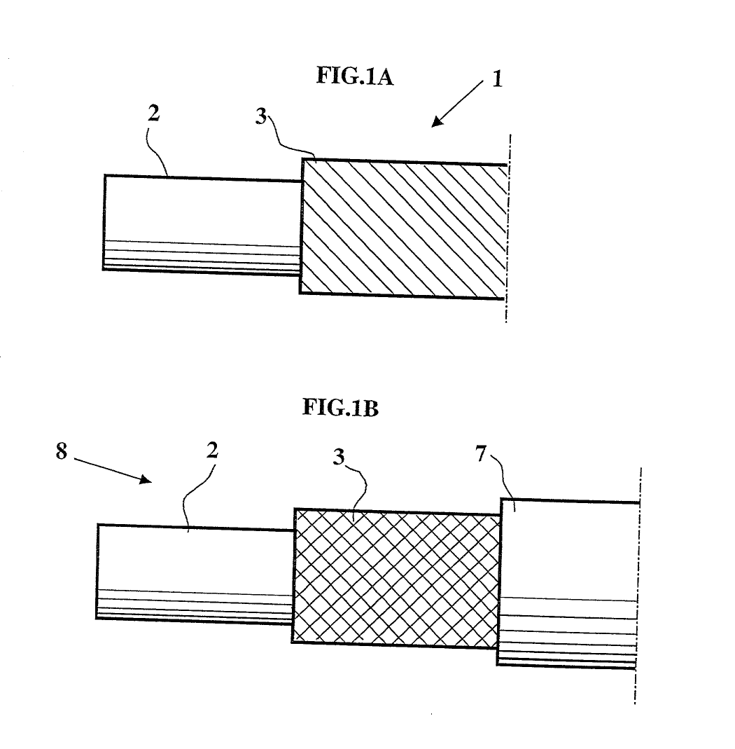

FIG. 1A is a cross-sectional view of a tube 1 according to the prior art consisting of a liner 2 used as a mandrel for coil 3 consisting of reinforcing fibers impregnated with a B-stage resin.

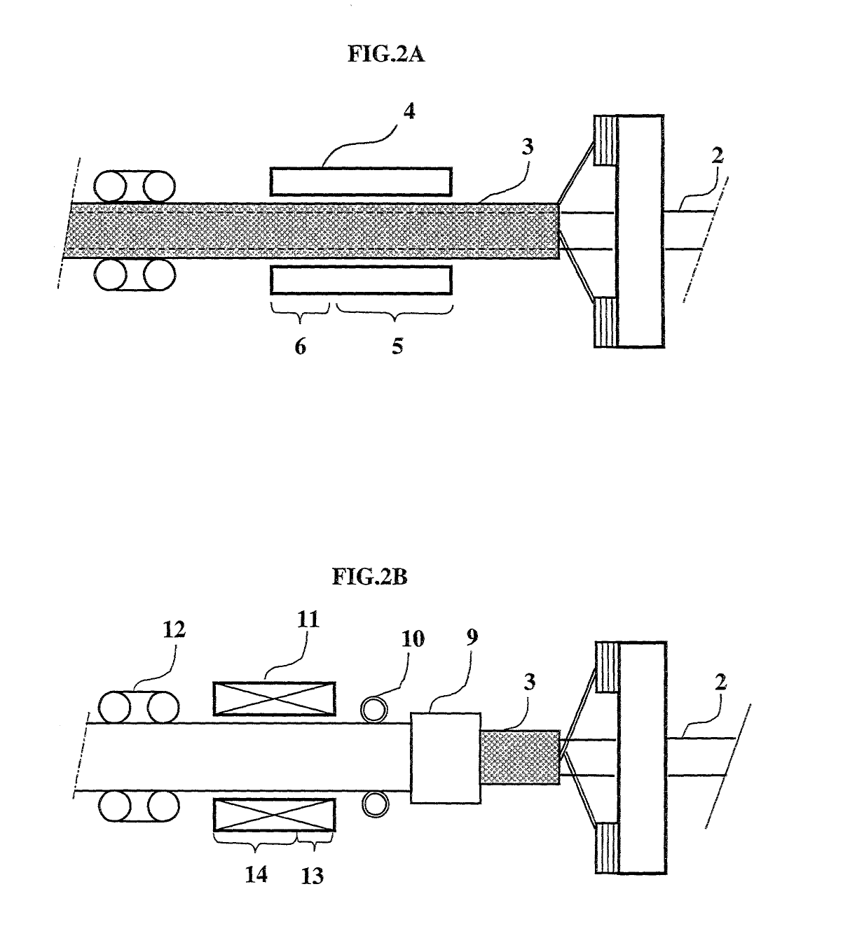

While entering oven 4 (FIG. 2A), liner 2 holds impregnated fiber structure 3 in position. The temperature rise in a first zone 5 of the oven causes fluidification of the resin which remains in a soft and pasty state. This viscosity decrease leads to gravity draining and deformation of the tube. As the structure progresses in translation towards the oven outlet, the viscosity of the resin changes gradually as polymerization and/or crosslinking is accomplished and it increases until the resin becomes rigid in zone 6. If the latency time of the resin is high, this soft and pasty state is relatively long. This poses problems for drawing the structure without deforming it before it becomes rigid. Furthermore, the oven can be excessively long, or the driving rate too slow.

In the case of the present invention, FIG. 1B shows a liner 2 on which are wound fibers 3 impregnated with B-stage resin, and a protection layer or shell 7 made of a hardenable material. FIG. 2B diagrammatically illustrates the process according to the invention. Liner 2 is coated with a layer 3 of reinforcing fibers embedded in resin, then it passes into a means 9 for manufacturing or setting the shell according to the invention. The tube thus formed is passed into oven 11. If the hardenable material of shell 7 is in an initially soft and pasty state, it is selected to rapidly reach its final hard and rigid stabilized state from the inlet of zone 13 of oven 11, whereas B-stage resin 3 still is in a soft and pasty state. As it is driven through zone 14, the polymerization of layer 3 continues without flutter or deformation problems because external shell 7, now rigid, maintains said layer 3 sandwiched between liner 2 and its inner surface. This shell thus allows a traction device to be installed from the start of the manufacturing process.

This protection shell can be made of a hardenable material whose reactivity is much higher than that of the resins used for the composite, or it can have a different chemical nature and aspect.

More generally, the resins used are hardenable by the action of the temperature or by other means such as, for example: UV or IR radiation, microwaves, or addition of polymerization initiators or catalysts, cements (sacrificial layer that can be eliminated afterwards, i.e. at the traction zone outlet), thermoplastic polymers, rigid foams, hardenable pre-impregnated cloths or equivalent means, i.e. all the materials likely to form a rigid layer, withstanding the polymerization temperature of the composite resins, i.e. which undergo no deformation, flow or alteration during the manufacture of the multilayer structure, rigidity having to be obtained rapidly.

In a particular application example, a vinyl ester type resin of high glass-transition temperature is used, which meets the defined criteria by:

ensuring, through its greater volume contraction upon polymerization, densification of the system which makes it more homogeneous, and therefore less deformable,

polymerizing at a relatively low temperature, which prevents draining of the fibers,

reaching a sufficient rigidity within a sufficiently short period of time,

allowing the structure to be handled in the oven without damage.

As in the first case, the polymerization temperature limitations of the assembly are inherent in the nature of liner 2 and of its physico-chemical properties (glass-transition temperature, softening temperature, fusion, etc.).

In a second example, a material pre-impregnated with an epoxide-amine type resin comprising a flow controller is used. The presence of a catalyst allows to obtain fast hardening of the protection shell.

In a third example, a material pre-impregnated with a mixture of thermoplastic and thermosetting polymer is used. After hardening, the composite allows draining problems to be prevented.

As in the previous cases, the polymerization temperature limitations of the assembly are inherent in the nature of liner 2 and of its physico-chemical properties (glass-transition temperature, softening temperature, fusion, etc.).

1) A method of manufacturing a part made of a composite material comprising reinforcing fibers embedded in a matrix made of a polymerizable and/or crosslinkable material characterized in that:
at least one layer (3) of said composite is deposited on a mandrel (2),
said non-polymerized and/or non-crosslinked composite layer is coated with at least one protection layer (7) made of a hardenable material,
said protection layer is hardened before polymerization and/or crosslinking of said composite layer.

2) A method as claimed in claim 1, wherein the material of said protection layer (7) is selected from the following group: thermosetting resins, thermoplastic polymers, mixtures of polymers, rigid foams, cements, impregnated cloths.

3) A method as claimed in any one of the previous claims, wherein said mandrel (2) is a continuous tube.

4) A method as claimed in any one of the previous claims, wherein said composite matrix is a B-stage composition.

5) A method as claimed in claim 4, wherein said matrix is a thermosetting composition, with low regain of water, oil and its components, with a glass-transition temperature of at least 100° C., preferably at least 120° C. and often at least 140° C., said composition comprising at least one epoxide resin consisting of at least one polyepoxide containing in its molecule at least two epoxide groups and of at least one aromatic polyamine comprising in its molecule at least two primary amino groups, at least one alkanoyl substituent having 1 to 12 carbon atoms located at alpha of one of the amino groups, the amine to epoxide molar ratio ranging between 1:1.6 and 1:2.6.

6) A method as claimed in any one of the previous claims, wherein said mandrel is a tube made of a thermoplastic polymer such as PE, PP, PA, PVDF, PEEK, extruded upstream from the stage of composite layer deposition.

7) A method as claimed in any one of claims 1 to 5, wherein said mandrel is a tube made of thermoplastic composite, thermosetting composite, composite of a mixture of thermoplastic polymers and thermosetting polymers.

8) A method as claimed in any one of claims 1 to 5, wherein said mandrel is a metal tube, a perforated metal or plastic tube, a metal or plastic lattice forming a tube, a rigid foam.

9) A method as claimed in any one of the previous claims, wherein said protection layer (7) is extruded.

10) A method as claimed in any one of the previous claims, wherein said protection layer (7) consists of at least one layer of reinforcing fibers, impregnated or embedded in an organic matrix.

11) A device for manufacturing a part made of a composite material comprising reinforcing fibers embedded in a matrix made of a polymerizable and/or crosslinkable material, characterized in that it comprises:
a mandrel (2) on which at least one layer (3) of said composite material is deposited,
means (9) for coating said layer (3) of non-polymerized and/or non-crosslinked composite material with at least one protection layer (7) made of a hardenable material,
means (11) for hardening said protection layer before polymerization and/or crosslinking of said composite layer.

12) A device as claimed in claim 11, wherein the manufacturing chain consists of:
means for extruding said mandrel,
means intended for filament winding of the composite layer on the mandrel,
means for extruding the protection layer on the composite layer,
means for polymerizing the composite.

13) A device as claimed in claim 12, wherein the means for hardening the protection layer are arranged upstream from said polymerization means.
